(19) United States
(12) Patent Application Publication
(10) Pub. No.: US 2009/0087604 A1
(43) Pub. Date: Apr. 2, 2009

(54) EXTRUDED TUBE FOR USE IN HEAT EXCHANGER

(76) Inventors: Graeme Stewart, Aylesford (GB); Kishan Padakannaya, Canton, MI (US); Jennifer Graham, Beverly Hills, MI (US)

Correspondence Address: FRASER CLEMENS MARTIN & MILLER LLC, 28366 KENSINGTON LANE, PERRYSBURG, OH, 43551, US

(21) Appl. No.: 11/862,629

(22) Filed: Sep. 27, 2007

(51) Int. Cl. B29D 23/00

(52) U.S. Cl. 428/35.8

(57) ABSTRACT

An extruded tube for a heat exchanger is disclosed, the tube including a plurality of deformations formed therein, wherein the deformations of the extruded tube facilitates a maximization of a thermal efficiency of the heat exchanger.

### FIELD OF THE INVENTION

The invention relates generally to an extruded tube for use in a heat exchanger, and more particularly to an extruded tube including a plurality of deformations formed on at least one surface thereof for use in a heat exchanger.

### BACKGROUND OF THE INVENTION

Heat exchangers are used for changing temperature of various working fluids, such as an engine coolant, an engine lubricating oil, an air conditioning refrigerant, and an automatic transmission fluid, for example. The heat exchanger typically includes a plurality of spaced apart fluid conduits or tubes connected between an inlet tank and an outlet tank, and a plurality of heat exchanging fins disposed between adjacent conduits. Air is directed across the fins of the heat exchanger by a cooling fan or a motion of a vehicle, for example. As the air flows across the fins, heat in a fluid flowing through the tubes is conducted through the walls of the tubes, into the fins, and transferred into the air.

One of the primary goals in heat exchanger design is to achieve the highest possible thermal efficiency. Thermal efficiency is measured by dividing the amount of heat that is transferred by the heat exchanger under a given set of conditions (amount of air flow, temperature difference between the air and fluid, and the like) by the theoretical maximum possible heat transfer under those conditions. Thus, an increase in the rate of heat transfer under a given set of conditions results in a higher thermal efficiency.

Typically, to improve thermal efficiency, the air flow must be improved, a pressure drop through the heat exchanger must be reduced, or a surface area of the tubes must be maximized. Prior art attempts to maximize the surface area of the tubes have had a negative affect on pressure drop within the tube, thus decreasing the thermal efficiency of the heat exchanger.

It would be desirable to produce an extruded tube for a heat exchanger, whereby a thermal efficiency of the heat exchanger is maximized, material usage is minimized, and a durability of the tube is maintained.

### SUMMARY OF THE INVENTION

Consistent and consonant with the present invention, an extruded tube for a heat exchanger, whereby a thermal efficiency of the heat exchanger is maximized, material usage is minimized, and a durability of the tube is maintained, has surprisingly been discovered.

In one embodiment, an extruded tube comprises a top wall, a bottom wall, and a pair of side walls having at least one flow passageway formed therein; at least one web disposed in the flow passageway and extending from at least one of the top wall and the bottom wall; and at least one deformation formed in at least one of the top wall, the bottom wall, and the side walls.

In another embodiment, an extruded tube for a heat exchanger comprises a top wall, a bottom wall, and a pair of side walls having a plurality of flow passageways formed therein; a web disposed in at least one of the flow passageways and extending from at least one of the top wall and the bottom wall; and a plurality of deformations formed on at least one of the top wall, the bottom wall, and the side walls.

In another embodiment, an extruded metal tube for a heat exchanger comprises a top wall, a bottom wall, and a pair of side walls having a plurality of flow passageways formed therein; a web disposed in each of the flow passageways and extending from at least one of the top wall and the bottom wall; and a plurality of deformations formed on the top wall, the bottom wall, and the side walls.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a perspective view of a heat exchanger in accordance with an embodiment of the invention;

FIG. 2 is a perspective view of a portion of an extruded tube disposed in the heat exchanger illustrated in FIG. 1;

FIG. 3 is a perspective view of a portion of an extruded tube in accordance with another embodiment of the invention;

FIG. 4 is a perspective view of a portion of an extruded tube in accordance with another embodiment of the invention;

FIG. 5 is a sectional view of an extruded tube in accordance with another embodiment of the invention; and

FIG. 6 is a sectional view of an extruded tube in accordance with another embodiment of the invention.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

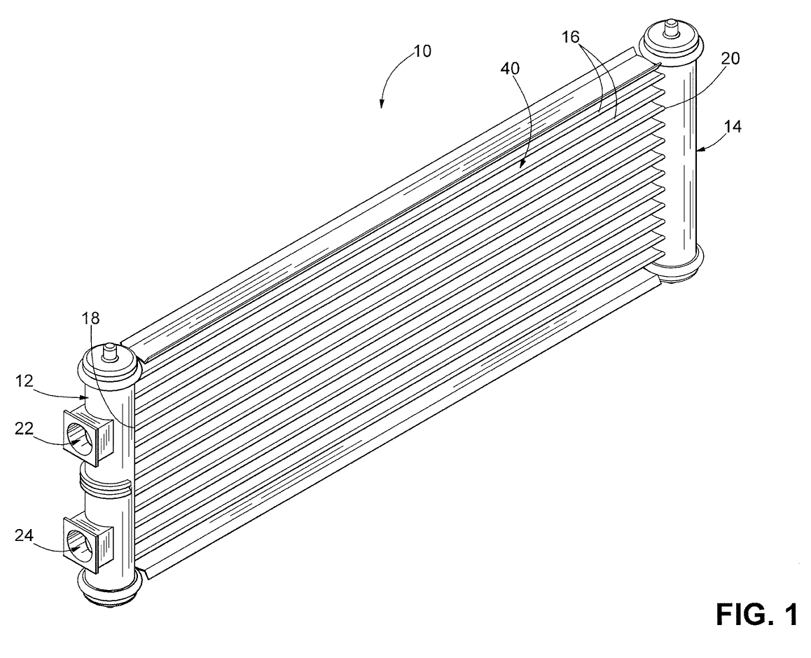

FIG. 1 shows a heat exchanger assembly 10 according to an embodiment of the invention. The heat exchanger assembly 10 includes a first manifold 12 and a second manifold 14 disposed on opposing ends thereof. In the embodiment shown, the heat exchanger assembly 10 is a U-flow type heat exchanger assembly. However, it is understood that other types of heat exchanger assemblies can be used such as a serpentine-flow type heat exchanger assembly, a parallel flow type heat exchanger assembly, and a multi-row parallel or counter-flow type heat exchanger assembly, for example. The heat exchanger assembly 10 also includes a plurality of substantially parallel tubes 16 disposed between and in fluid communication with the first manifold 12 and the second manifold 14. Each of the tubes 16 is connected at a first end 18 to the first manifold 12, and at a second end 20 to the second manifold 14. In the embodiment shown, the manifolds 12, 14 and the tubes 16 are formed from aluminum. However, any suitable material can be used, as desired.

The first manifold 12 includes an inlet fitting 22, a plurality of tube openings (not shown) formed therein for receiving the first ends 18 of the tubes 16, and an outlet fitting 24. The inlet fitting 22 is adapted to communicate with a source of coolant (not shown). The tube openings provide fluid communication between the first manifold 12 and the tubes 16. The outlet fitting 24 provides an exit for the coolant flowing through the heat exchanger assembly 10 and is typically in communication with the source of coolant or other storage system. A baffle (not shown) is sealingly disposed in the first manifold between the inlet fitting 22 and the outlet fitting 24 to create a substantially fluid tight seal therebetween.

The second manifold 14 includes a plurality of tube openings (not shown) formed therein for receiving the second ends 20 of the tubes 16. The tube openings provide fluid communication between the tubes 16 and the second manifold 14.

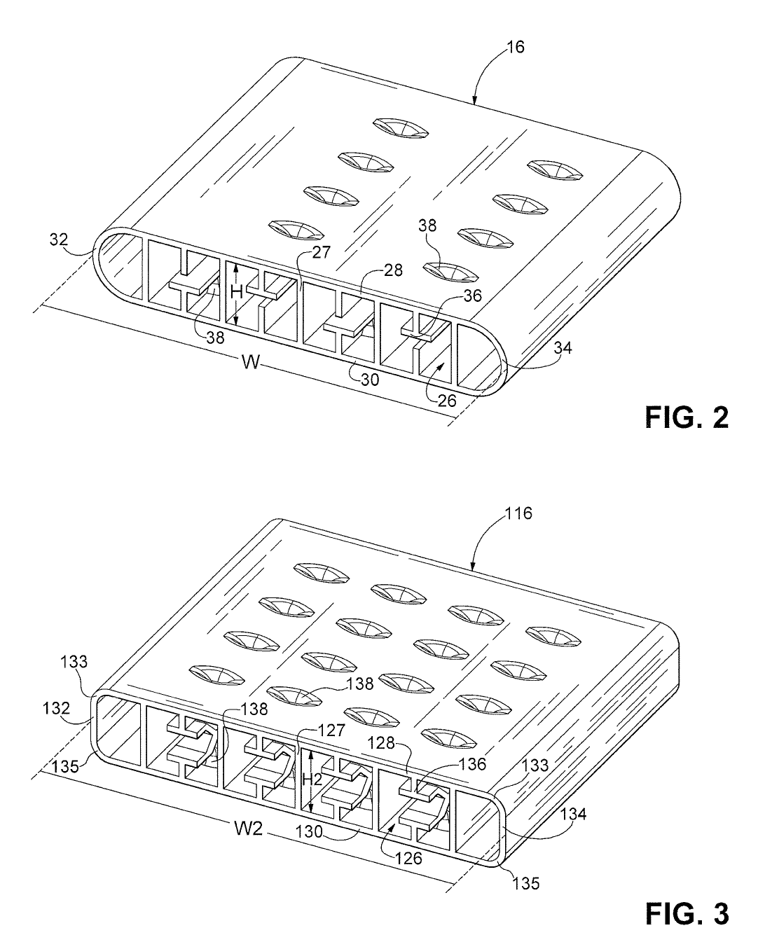

As more clearly shown in FIG. 2, the tubes 16 are generally rectangular shaped in cross section and include a plurality of flow passageways 26 formed therein. The flow passageways 26 extend longitudinally through the tubes 16 and are divided from one another by a plurality of tube dividers 27. It is understood that the tubes 16 may have any cross-sectional shape as desired. The tubes 16 have a tube height H defined by a distance between a substantially planar top wall 28 and a substantially planar bottom wall 30. The tubes 16 also include a tube width W defined by a distance between a first side wall 32 and a second side wall 34. In the embodiment shown, the side walls 32, 34 are generally arcuate in shape, but may have other shapes. The tubes 16 include at least one internal web 36 extending from one or both of the top wall 28 and the bottom wall 30 in each of the flow passageways 26 in the tubes 16. In the embodiment shown, the webs 36 have a T-shape in cross section or a generally linear cross-sectional shape. It is understood the webs 36 can have other cross-sectional shapes as desired. A tube length (not shown) is defined by a distance between the respective manifolds 12, 14.

The tubes 16 include a plurality of deformations 38 formed therein. In the embodiment shown, the deformations 38 are formed on the top wall 28 and the bottom wall 30 of the tubes 16. However, it is understood that the deformations 38 can be formed on only one of the top wall 28 and the bottom wall 30, and may also be formed on the side walls 32, 34 of the tubes 16. As shown, the deformations 38 are formed as indentations or recesses in exterior surfaces of the top wall 28 and the bottom wall 30 which form corresponding protuberances or ridges on interior surfaces of the top wall 28 and the bottom wall 30. The deformations 38 are formed on the top wall 28 and the bottom wall 30 in a generally repeating pattern in the embodiment shown, wherein the deformations 38 are formed in alternating flow passageways 26 and are substantially evenly spaced along the length and width W of the tubes 16. It is understood that other patterns can be formed on the tubes 16 as desired. The deformations 38 cause the webs 36 to protrude toward and abut or nearly abut one another.

As shown in FIG. 1, the tubes 16 are generally evenly spaced and have spaces 40 formed therebetween. A plurality of fins (not shown) may be disposed within the spaces 40 between each adjacent tube 16. The fins typically have a corrugated shape with a series of convolutes that extend between adjacent tubes 16, as is known in the art. A series of louvers (not shown) may be provided on each corrugation of the fins to further aid in heat transfer to the air passing therethrough.

In use, a first fluid (not shown) is caused to flow through the inlet fitting 22 into a first section of the first manifold 12 on a first side of the baffle. The first fluid can be any conventional fluid such as automatic transmission fluid, power steering fluid, or engine oil, for example. The first fluid then flows into the flow passageways 26 of a first set of the tubes 16 through the corresponding tube openings formed in the first section of the first manifold 12. The first fluid contains thermal energy which is transferred to the interior surfaces of the tubes 16 as the first fluid flows through the flow passageways 26. A second fluid (not shown) is caused to flow through the spaces 40 between adjacent tubes 16, and contacts the exterior surfaces of the tubes 16. The second fluid can be any conventional fluid such as air, for example. The thermal energy transferred to the tubes 16 by the first fluid is transferred to the second fluid as the second fluid contacts the exterior surfaces of the tubes 16.

The first fluid then flows into and out of the second manifold 14 in a U-shaped pattern as is known in the art. Upon exiting the second manifold 14, the first fluid flows through a second set of the tubes 16 corresponding to a second section of the first manifold 12 on a second side of the baffle. The first fluid then enters the second section of the first manifold 12 through the corresponding tube openings formed therein, and out of the first manifold 12 through the outlet fitting 24. When flowing through the tubes 16 corresponding to the second section of the first manifold 12, additional heat is transferred from the first fluid to the second fluid as previously described herein.

The deformations 38 formed in the tubes 16 provide additional surface area for the first fluid to contact within the flow passageways 26 of the tubes 16. Further, within each of the flow passageways 26, a fluid boundary layer is caused to detach from the interior surface of the tube 16 at the deformations 38 as the first fluid changes direction. The fluid boundary layer then reestablishes itself and continues to grow downstream of the deformation 38. The fluid boundary layer is caused to detach repeatedly in a periodic pattern. The periodic detachment of the fluid boundary layer and change in fluid direction maximizes the transfer of thermal energy from the first fluid to the interior surface of the tubes 16 by disrupting a laminar flow pattern of the first fluid. Accordingly, a thermal efficiency of the heat exchanger assembly 10 is maximized.

FIG. 3 shows a tube 116 according to another embodiment of the invention. The tube 116 is generally rectangular shaped in cross section and includes a plurality of flow passageways 126 extending longitudinally therethrough. The flow passageways 126 are divided from one another by a plurality of tube dividers 127. It should be appreciated that the tube 116 may have any cross-sectional shape. The tube 116 has a tube height H2 defined by a distance between a top wall 128 and a bottom wall 130 thereof. The top wall 128 and the bottom wall 130 are generally planar. Additionally, the tube 116 includes a tube width W2 defined by a distance between a first side wall 132 and a second side wall 134. In the embodiment shown, the side walls 132, 134 are generally planar and have arcuate upper and lower portions 133, 135, but may have any shape. The tube 116 includes at least one internal web 136 extending from at least one of the top wall 128 and the bottom wall 130 in the flow passageways 126. In the embodiment shown, the webs 136 have a cross-sectional T-shape, but may have other cross-sectional shapes as desired.

The tube 116 includes a plurality of deformations 138 formed therein. In the embodiment shown, the deformations 138 are formed on the top wall 128 and the bottom wall 130 of the tube 116. However, it is understood that the deformations 138 can be formed on only one of the top wall 128 and the bottom wall 130, and may also be formed on the side walls 132, 134 of the tubes 16 as desired. The deformations 138 are formed as indentations or recesses in exterior surfaces of the top wall 128 and the bottom wall 130, and corresponding protuberances on interior surfaces of the top wall 128 and the bottom wall 130. The deformations 138 are formed on the top wall 128 and the bottom wall 130 in generally repeating patterns in the embodiment shown, wherein the deformations 138 are formed in adjacent flow passageways 126 and are substantially evenly spaced apart along the length and width W2 of the tube 116. It is understood that other patterns of deformations 138 can be formed on the tube 116 as desired, such as a random pattern, for example. The deformations 138 cause the webs 136 to protrude toward and abut or nearly abut one another.

Use of the tube 116 is substantially the same as previously described herein for the tube 16. Similarly, the deformations 138 formed on the tubes 116 provide for additional surface area for thermal energy transferred from the first fluid to the tubes 116. Accordingly, a thermal efficiency of the heat exchanger assembly 10 is maximized.

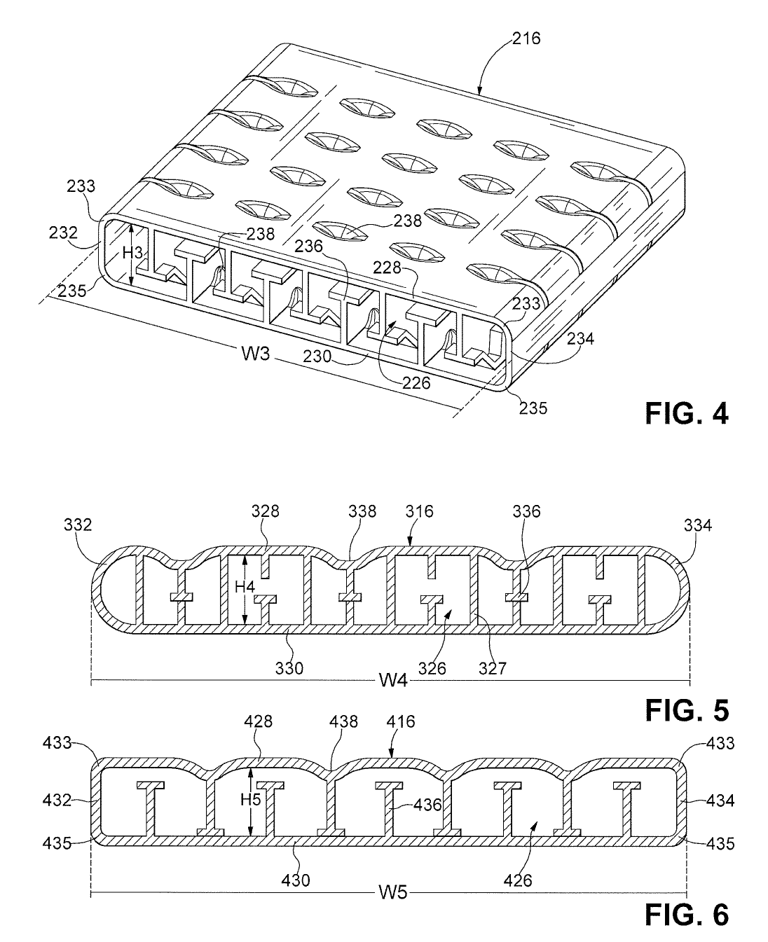

FIG. 4 shows a tube 216 according to another embodiment of the invention. The tube 216 is generally rectangular shaped in cross section and includes a plurality of flow passageways 226 extending longitudinally therethrough. It should be appreciated that the tube 216 may have any cross-sectional shape. The tube 216 has a tube height H3 defined by a distance between a top wall 228 and a bottom wall 230 thereof. The top wall 228 and the bottom wall 230 are generally planar. Additionally, the tube 216 includes a tube width W3 defined by a distance between a first side wall 232 and a second side wall 234. In the embodiment shown, the side walls 232, 234 are generally planar and have arcuate upper and lower portions 233, 235, but may have any suitable shape. The tube 216 includes at least one internal web 236 extending from at least one of the top wall 228 and the bottom wall 230 to divide the flow passageways 226 in the tube 216. In the embodiment shown, the webs 236 have a cross-sectional T-shape, but may have other cross-sectional shapes as desired.

The tube 216 includes a plurality of deformations 238 formed therein. In the embodiment shown, the deformations 238 are formed on the top wall 228, the bottom wall 230, and the arcuate upper and lower portions 233, 235 of the side walls 232, 234 of the tube 216. The deformations 238 are formed as indentations or recesses in exterior surfaces of the top wall 228, the bottom wall 230, and the arcuate upper and lower portions 233, 235 and corresponding protuberances on interior surfaces of the top wall 228, the bottom wall 230, and the arcuate shaped upper and lower portions 233, 235. The deformations 238 are formed on the top wall 228, the bottom wall 230, and the arcuate shaped upper and lower portions 233, 235 of the side walls 232, 234 in generally repeating patterns in the embodiment shown, wherein the deformations 238 are formed in adjacent flow passageways 226 and on the arcuate shaped upper and lower portions 233, 235 of the side walls 232, 234, and are substantially evenly spaced apart along the length and width W3 of the tube 216. It is understood that other patterns of deformations 238 can be formed on the tube 216 as desired, such as a random pattern, for example. The deformations 238 cause the webs 236 to protrude toward and abut or nearly abut the interior surface of the tube 216.

Use of the tube 216 is substantially the same as previously described herein for the tube 16. Similarly, the deformations 238 formed on the tubes 216 provide for additional surface area for thermal energy transferred from the first fluid to the tubes 216. Accordingly, a thermal efficiency of the heat exchanger assembly 10 is maximized.

FIG. 5 shows a tube 316 according to another embodiment of the invention. The tube 316 is generally rectangular shaped in cross section and includes a plurality of flow passageways 326 extending longitudinally therethrough. The flow passageways 326 are divided from one another by a plurality of tube dividers 327. It should be appreciated that the tube 316 may have any suitable cross-sectional shape. The tube 316 has a tube height H4 defined by a distance between a top wall 328 and a bottom wall 330 thereof. The top wall 328 and the bottom wall 330 are generally planar. Additionally, the tube 316 includes a tube width W4 defined by a distance between a first side wall 332 and a second side wall 334. In the embodiment shown, the side walls 332, 334 are generally arcuate, but may have any shape as desired. The tube 316 includes at least one internal web 336 extending from at least one of the top wall 328 and the bottom wall 330 in each of the flow passageways 326. The webs 336 have one of a T-shaped cross-sectional shape or a linear cross-sectional shape, but may have other cross-sectional shapes as desired.

The tube 316 includes a plurality of deformations 338 formed thereon. In the embodiment shown, the deformations 338 are formed on the top wall 328 of the tube 316. However, it is understood that the deformations 338 can be formed on the bottom wall 330 and the side walls 332, 334 of the tube 316 as desired. The deformations 338 are formed as indentations or recesses in an exterior surface of the top wall 328 and corresponding protuberances on an interior surface of the top wall 328. The deformations 338 are formed on the top wall 328 in a generally repeating pattern in the embodiment shown, wherein the deformations 338 are formed in alternating flow passageways 326, and are substantially evenly spaced apart along the length and width W4 of the tube 316. It is understood that other patterns of deformations 338 can be formed on the tube 316 as desired, such as a random pattern, for example. The deformations 338 cause the webs 336 to protrude toward and abut or nearly abut one another.

Use of the tube 316 is substantially the same as previously described herein for the tube 16. Similarly, the deformations 338 formed on the tubes 316 provide for additional surface area for thermal energy transferred from the first fluid to the tubes 316. Accordingly, a thermal efficiency of the heat exchanger assembly 10 is maximized.

FIG. 6 shows a tube 416 according to another embodiment of the invention. The tube 416 is generally rectangular shaped in cross section and includes a flow passageway 426 extending longitudinally therethrough. It should be appreciated that the tube 416 may have any cross-sectional shape. The tube 416 has a tube height H5 defined by a distance between a top wall 428 and a bottom wall 430 thereof. The top wall 428 and the bottom wall 430 are generally planar. Additionally, the tube 416 includes a tube width W5 defined by a distance between a first side wall 432 and a second side wall 434. In the embodiment shown, the side walls 432, 434 are generally planar and have arcuate upper and lower portions 433, 435, but may have any suitable shape. The tube 416 includes at least one internal web 436 extending from at least one of the top wall 428 and the bottom wall 430. The webs 436 have a T-shaped cross section, but may have other cross-sectional shapes as desired.

The tube 416 includes a plurality of deformations 438 formed therein. In the embodiment shown, the deformations 438 are formed in the top wall 428 of the tube 416. However, it is understood that the deformations 438 can be formed in the bottom wall 430 and the side walls 332, 334 as desired. The deformations 438 are formed as indentations or recesses in an exterior surface of the top wall 428 and corresponding protuberances on an interior surface of the top wall 428. The deformations 438 are formed in the top wall 428 in a generally repeating pattern in the embodiment shown, wherein the deformations 438 are formed in the flow passageway 426 and are substantially evenly spaced along the length and width W5 of the tube 416. It is understood that other patterns of deformations 438 can be formed in the tube 416 as desired such as a random pattern, for example. The deformations 438 cause the webs 436 to protrude toward and abut or nearly abut the interior surface of the tube 416.

Used of the tube 416 is substantially the same as previously described herein for the tube 16. Similarly, the deformations 438 formed on the tubes 416 provide for additional surface area for thermal energy transferred from the first fluid to the tubes 416. Accordingly, a thermal efficiency of the heat exchanger assembly 10 is maximized.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An extruded tube comprising:
a top wall, a bottom wall, and a pair of side walls having at least one flow passageway formed therein;
at least one web disposed in the flow passageway and extending from at least one of the top wall and the bottom wall; and
at least one deformation formed in at least one of the top wall, the bottom wall, and the side walls.

2. The tube according to claim 1, wherein the web has a T-shaped cross section.

3. The tube according to claim 1, wherein the web is substantially linear.

4. The tube according to claim 1, wherein the tube is formed from aluminum.

5. The tube according to claim 1, wherein the tube is formed as part of a heat exchanger assembly and the heat exchanger assembly is one of a parallel flow type heat exchanger assembly, a serpentine-flow type heat exchanger assembly, and a U-flow type heat exchanger assembly.

6. The tube according to claim 1, wherein arcuate shaped portions of the side walls include the at least one deformation formed therein.

7. The tube according to claim 1, wherein both the top wall and the bottom wall include the at least one deformation formed therein.

8. An extruded tube for a heat exchanger comprising:
a top wall, a bottom wall, and a pair of side walls having a plurality of flow passageways formed therein;
a web disposed in at least one of the flow passageways and extending from at least one of the top wall and the bottom wall; and
a plurality of deformations formed on at least one of the top wall, the bottom wall, and the side walls.

9. The tube according to claim 8, wherein the tube is formed from a metal.

10. The tube according to claim 9, wherein the tube is formed from aluminum.

11. The tube according to claim 8, wherein arcuate portions of the side walls include the deformations formed therein.

12. The tube according to claim 8, wherein both the top wall and the bottom wall include the deformations formed therein.

13. The tube according to claim 8, wherein a tube divider divides adjacent flow passageways formed in the tube.

14. The tube according to claim 8, wherein the deformations are formed in at least one of the top wall and the bottom wall of adjacent flow passageways.

15. The tube according to claim 8, wherein the deformations are formed in at least one of the top wall and the bottom wall of alternating flow passageways.

16. An extruded metal tube for a heat exchanger comprising:
a top wall, a bottom wall, and a pair of side walls having a plurality of flow passageways formed therein;
a web disposed in each of the flow passageways and extending from at least one of the top wall and the bottom wall; and
a plurality of deformations formed on at least one of the top wall, the bottom wall, and the side walls.

17. The tube according to claim 16, wherein the tube is formed from aluminum.

18. The tube according to claim 16, wherein arcuate portions of the side walls include the deformations formed therein.

19. The tube according to claim 16, wherein the deformations formed on the top wall and the bottom wall are formed in adjacent flow passageways.

20. The tube according to claim 16, wherein the deformations formed the top wall and the bottom wall are formed in alternating flow passageways.
